(19) United States
(12) Patent Application Publication
(10) Pub. No.: US 2024/0322453 A1
(43) Pub. Date: Sep. 26, 2024

(54) TRANSMISSION APPARATUS AND TRANSMISSION METHOD

(71) Applicant: NIPPON TELEGRAPH AND TELEPHONE CORPORATION, Tokyo (JP)

(72) Inventors: Takayuki YAMADA, Tokyo (JP); Doohwan LEE, Tokyo (JP); Jun MASHINO, Tokyo (JP); Hirofumi SASAKI, Tokyo (JP); Yasunori YAGI, Tokyo (JP); Tomoya KAGEYAMA, Tokyo (JP)

(21) Appl. No.: 18/574,172

(22) PCT Filed: Jul. 13, 2021
(86) PCT No.: PCT/JP2021/026308

§ 371 Date: Dec. 26, 2023

(51) Int. Cl. H01Q 21/20; H04B 7/0413

(52) U.S. Cl. CPC H01Q 21/20; H04B 7/0413

(57) ABSTRACT

A transmission apparatus includes: a spherical array antenna including a plurality of antenna elements on a spherical surface; and a control unit that selects a plurality of antenna elements present on any circle from among the plurality of antenna elements of the spherical array antenna as a UCA and causes the selected UCA to perform OAM transmission.

### TECHNICAL FIELD

The present invention relates to a technique of spatially multiplexing and transmitting wireless signals by using the orbital angular momentum (OAM) of electromagnetic waves.

### BACKGROUND ART

In recent years, a technique for improving a transmission capacity by spatially multiplexing and transmitting wireless signals by using OAM has been studied (for example, Non Patent Literature 1). In electromagnetic waves having OAM, an equiphase surface is spirally distributed in a propagation direction around a propagation axis. Since electromagnetic waves having different OAM modes and propagating in the same direction have spatial phase distributions orthogonal to each other in a rotation axis direction, it is possible to multiplex and transmit signals by separating the signals in respective OAM modes modulated with different signal sequences in a reception station.

In a wireless communication system using the OAM multiplexing technology, spatial multiplex transmission of different signal sequences can be realized by generating, combining, and transmitting a plurality of OAM modes by using a uniform circular array (hereinafter referred to as a UCA) in which a plurality of antenna elements are circularly disposed at equal intervals (for example, Non Patent Literature 2). For example, a Butler circuit (Butler matrix circuit) is used to generate signals in a plurality of OAM modes. However, using a Butler circuit is an example.

Signals in the same OAM mode can be multiplexed and transmitted by a multiplex UCA in which a plurality of UCAs having different diameters are concentrically disposed. The signals multiplexed in the same OAM mode can be separated according to a MIMO technology on a reception side.

### CITATION LIST

### Non Patent Literature

Non Patent Literature 1: J. Wang et al., “Terabit free-space data transmission employing orbital angular momentum multiplexing,” Nature Photonics, Vol. 6, pp. 488-496, July 2012.
Non Patent Literature 2: Y. Yan et al., “High-capacity millimeter-wave communications with orbital angular momentum multiplexing,” Nature Commun., vol. 5, p. 4876, September 2014.

### SUMMARY OF INVENTION

### Technical Problem

As described above, a transmission device using the UCA enables large-capacity communication, but it is desired to handle mobile communication in the future. In order to apply an OAM multiplex transmission technology to mobile communication, multidirectional support or movement following performance that allow signals to be transmitted in multiple directions are required.

However, in the conventional wireless transmission technology using a UCA, in order to separate signals in a plurality of OAM modes without interference between the modes, it is necessary to install a transmission antenna and a reception antenna at positions facing each other on the front, and thus there is a problem in that multidirectional non-support and low movement following performance are caused because axial alignment is required.

The present invention has been made in view of the above circumstances, and an object of the present invention is to provide a technology that enables multidirectional support and movement following in a transmission device using a UCA.

### Solution to Problem

According to the disclosed technology, there is provided a transmission device including:
a spherical array antenna including a plurality of antenna elements on a spherical surface; and
a control unit that selects a plurality of antenna elements present on any circle from among the plurality of antenna elements of the spherical array antenna as a UCA and causes the selected UCA to perform OAM transmission.

### Advantageous Effects of Invention

According to the disclosed technology, there is provided a technology that enables multidirectional support and movement following in a transmission device (transmission apparatus) using UCA.

### BRIEF DESCRIPTION OF DRAWINGS

FIG. 1 is a diagram illustrating a phase setting example of a UCA for generating a signal in an OAM mode.

FIG. 2 is a diagram illustrating an example of a phase distribution and a signal intensity distribution of an OAM multiplex signal.

FIG. 3 is a diagram illustrating an example of an antenna configuration including a plurality of UCAs concentrically.

FIG. 4 is a diagram for describing a basic concept of the technology according to an embodiment of the present invention.

FIG. 5 is a diagram illustrating an example of a spherical array antenna according to the embodiment of the present invention.

FIG. 6 is a diagram illustrating an example of a spherical array antenna according to the embodiment of the present invention.

FIG. 7 is a diagram illustrating an example of a spherical array antenna according to the embodiment of the present invention.

FIG. 8 is a diagram illustrating an example of a spherical array antenna according to the embodiment of the present invention.

FIG. 9 is a diagram for describing an antenna element.

FIG. 10 is a diagram illustrating a configuration example of a transmission device according to the embodiment of the present invention.

FIG. 11 is a diagram illustrating a configuration example of a transmission device according to the embodiment of the present invention.

FIG. 12 is a diagram illustrating a configuration example of a transmission device according to the embodiment of the present invention.

FIG. 13 is a diagram illustrating a configuration example of a changeover switch unit 30.

FIG. 14 is a diagram illustrating a configuration example of an OAM mode generation unit 40.

FIG. 15 is a flowchart illustrating a flow of signal processing.

FIG. 16 is a diagram illustrating an example of transmission using a selected UCA.

FIG. 17 is a diagram illustrating an example of transmission using a selected UCA.

### DESCRIPTION OF EMBODIMENTS

An embodiment (the present embodiment) of the present invention will be described below with reference to the drawings. The embodiment described below is merely an example, and embodiments to which the present invention is applied are not limited to the embodiment described below.

### Basic Operation Example

First, a basic setting/operation example related to a UCA used in a transmission device (transmission apparatus) in the present embodiment will be described.

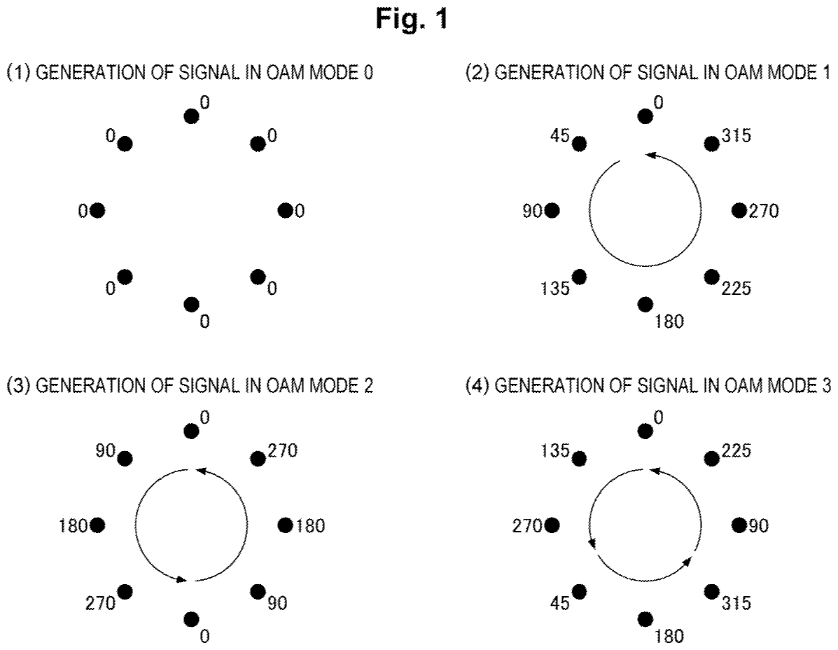

FIG. 1 illustrates a phase setting example of a UCA for generating a signal in an OAM mode. The UCA illustrated in FIG. 1 is a UCA including eight antenna elements.

In FIG. 1, signals in the OAM modes 0, 1, 2, 3, . . . on a transmission side are generated by phase differences of signals supplied to the antenna elements (indicated by •) of the UCA. That is, a signal in an OAM mode n is generated by setting a phase of the signal to be supplied to each antenna element such that the phase rotates by n (n×360 degrees). For example, in a case where the UCA includes m=8 antenna elements as illustrated in FIG. 1, and a signal in the OAM mode n=2 is generated, as illustrated in FIG. 1(3), a phase difference (0 degrees, 90 degrees, 180 degrees, 270 degrees, 0 degrees, 90 degrees, 180 degrees, 270 degrees) of 360 n/m=90 degrees is set in each antenna element counterclockwise such that the phase rotates twice.

A signal of which a phase rotation direction is reversed to the signal in the OAM mode n is referred to as an OAM mode-n. For example, a phase rotation direction of a signal in a positive OAM mode is set to the counterclockwise direction, and a phase rotation direction of a signal in a negative OAM mode is set to the clockwise direction.

By generating different signal sequences as signals in different OAM modes and simultaneously transmitting the generated signals, it is possible to perform wireless communication according to spatial multiplexing in which a plurality of OAM modes are multiplexed. The same signal sequence may be generated as signals in different OAM modes, and the generated signals may be simultaneously transmitted.

In order to separate an OAM multiplex signal on a reception side, a phase of each antenna element of a UCA on the reception side may be set to be reverse to a phase of an antenna element on the transmission side.

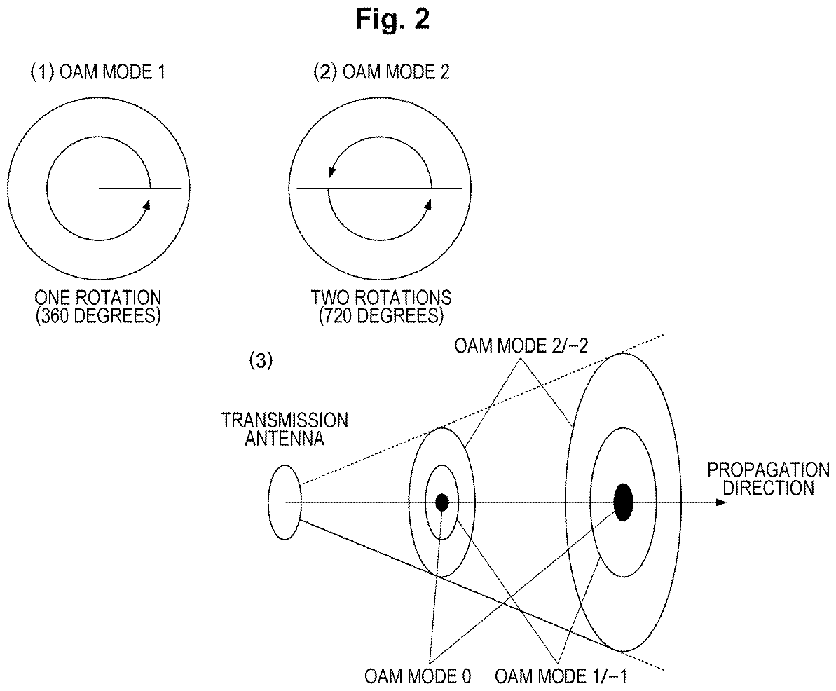

FIG. 2 illustrates an example of a phase distribution and a signal intensity distribution of an OAM multiplex signal. In FIGS. 2(1) and 2(2), phase distributions of signals in OAM mode 1 and OAM mode 2 viewed from the transmission side at an end face (propagation orthogonal plane) orthogonal to the propagation direction are indicated by arrows. The beginning of the arrow is 0 degrees, the phase changes linearly, and the end of the arrow is 360 degrees. That is, the signal in the OAM mode n propagates while the phase rotates by n (n×360 degrees) in the propagation orthogonal plane. The arrows of phase distributions of the signals in the OAM modes −1 and −2 are in reverse directions.

In the signal in each OAM mode, a signal intensity distribution and a position where the signal intensity is maximized are different for each OAM mode. However, the intensity distributions of the same OAM mode having different signs are the same. Specifically, as the OAM mode becomes higher, a position where the signal intensity is maximized becomes farther from the propagation axis (Non Patent Literature 2). Here, a mode having a greater value in the OAM mode will be referred to as a higher mode. For example, the signal in the OAM mode 3 is in a higher mode than the signals in the OAM mode 0, the OAM mode 1, and the OAM mode 2.

In FIG. 2(3), a position where the signal intensity is maximized is indicated by a circular ring for each OAM mode. As the OAM mode becomes higher, the position where the signal intensity is maximized becomes farther from the central axis, and a beam diameter of the OAM mode multiplex signal widens according to a propagation distance, and the circular ring indicating the position where the signal intensity is maximized widens for each OAM mode.

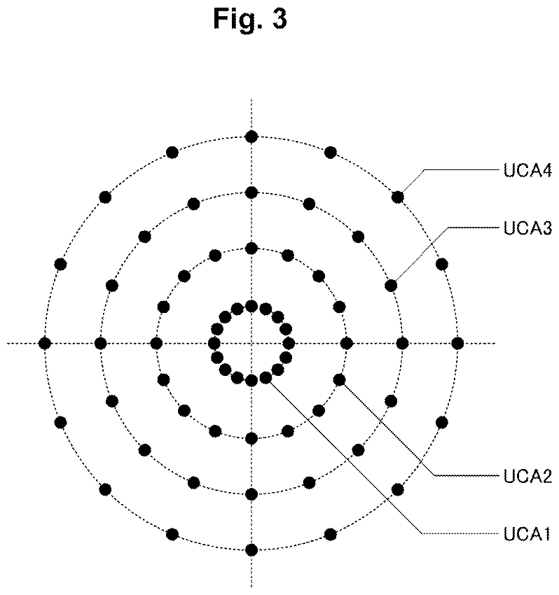

For example, as illustrated in FIG. 3, signals in the same OAM mode can be multiplexed and transmitted by a multiplex UCA in which a plurality of UCAs having different diameters are concentrically disposed. The signals multiplexed in the same OAM mode can be separated according to a MIMO technology on a reception side. FIG. 3 illustrates an example of a multiplex UCA in which four UCAs having different diameters are disposed concentrically.

### Outline of Embodiment of Present Invention

As described above, the transmission device (transmission apparatus) using the UCA enables large-capacity communication. However, in the conventional wireless transmission technology using the UCA, communication in multiple directions is not supported, and movement following performance is also low.

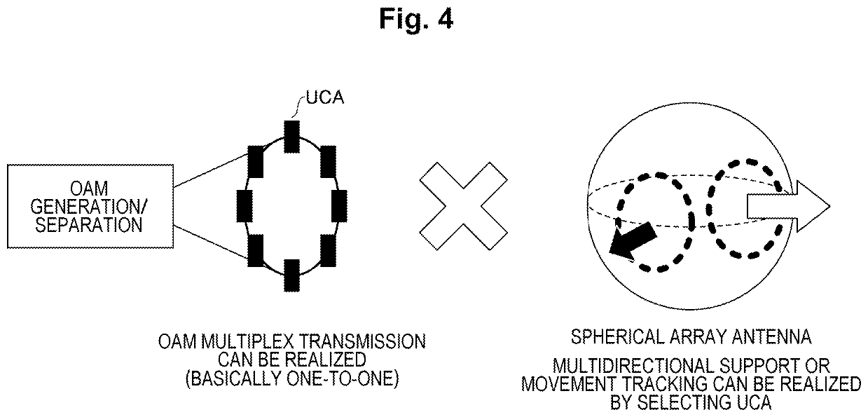

Therefore, in the present embodiment, a spherical array antenna in which a plurality of antenna elements are disposed on a spherical surface is used, and as illustrated in FIG. 4, a UCA in which a transmission axis matches a transmission direction is selected from antenna elements configuring a spherical array, and OAM multiplex transmission is performed. Consequently, multidirectional support and movement following can be realized. A sphere configuring a “spherical surface” may not be a strict sphere. A sphere having a shape somewhat distorted from a sphere is also acceptable. Further, transmission using one OAM mode may be performed. “OAM transmission” includes OAM multiplex transmission.

### Configuration Example of Spherical Array Antenna

The spherical array antenna in the present embodiment includes a plurality of antenna elements on the surface of a sphere. A direction (orientation) of each antenna element is variable.

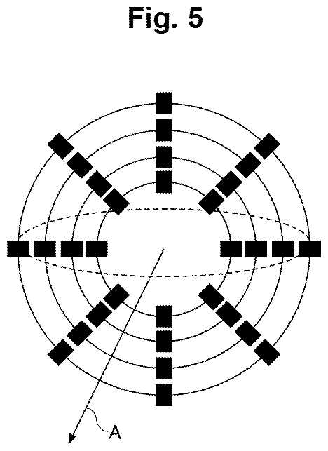

A configuration example of the spherical array antenna is illustrated in FIG. 5. FIG. 5 illustrates an image of the spherical array antenna as viewed from a direction of the transmission axis indicated by A. In FIG. 5, the transmission axis indicated by A is directed to the side of viewing the drawing perpendicular to the paper surface of the drawing, but for convenience of illustration, the transmission axis is illustrated as inclined.

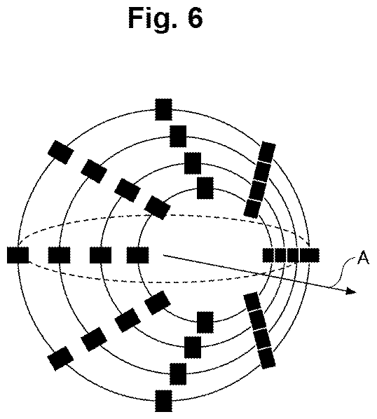

Each black square indicates an antenna element. For a plurality of antenna elements existing on one circle, the circle is drawn to pass through the plurality of antenna elements. FIG. 6 illustrates an image of the spherical array antenna of FIG. 5 as viewed obliquely.

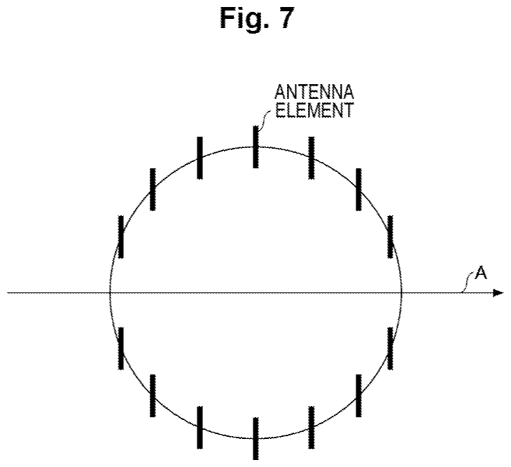

FIG. 7 illustrates an example of a sectional view of the spherical array antenna illustrated in FIG. 5 taken along a plane including the transmission axis A (a plane including the antenna element). FIG. 7 illustrates an example in which each antenna element is a planar antenna element. Therefore, the cross section is linear. In the antenna element, it is assumed that the radiation intensity in the direction perpendicular to the plane is maximum.

As illustrated in the sectional view of FIG. 7, the antenna elements are disposed on a circle of the cross section of the sphere. A direction of each antenna element (the direction in which the radiation intensity is maximum) is the direction of the transmission axis. Note that, in the example of FIG. 7, directions of all the antenna elements are directed toward the transmission axis, but only antenna elements configuring a UCA to be used for transmission need to be directed toward the transmission axis.

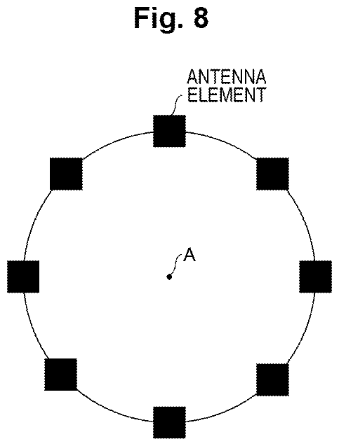

FIG. 8 illustrates a sectional view of the spherical array antenna illustrated in FIG. 5 taken along a plane perpendicular to the transmission axis A (a plane including the antenna element). As illustrated in FIG. 8, one UCA is configured.

In a case where the transmission axis A is directed in any direction, the UCA as illustrated in FIG. 8 may be configured by selecting a plurality of antenna elements disposed in a circle on a plane perpendicular to the transmission axis A. Since a direction of the antenna element is variable, the directivity (a direction in which the radiation intensity is maximized) of each antenna element configuring the UCA can be directed to the direction of the transmission axis.

As in the image illustrated in FIG. 4, by selecting a plurality of antenna elements disposed in a circle on a plane perpendicular to the transmission axis for each of the plurality of transmission axes, OAM multiplex transmission in a plurality of directions using a plurality of UCAs at the same time can be realized.

By selecting a plurality of planes perpendicular to one transmission axis, it is possible to select a plurality of antenna elements disposed on circles having different concentric diameters as illustrated in FIG. 3, and it is also possible to perform OAM-MIMO multiplex transmission in any direction.

Note that, in the present embodiment, an example in which a plurality of antenna elements are disposed on a spherical surface has been described, but the present invention is not limited thereto. For example, antenna elements may also be disposed inside a sphere. In this case, a cross section of the sphere provides, for example, the disposition of the antenna elements illustrated in FIG. 3.

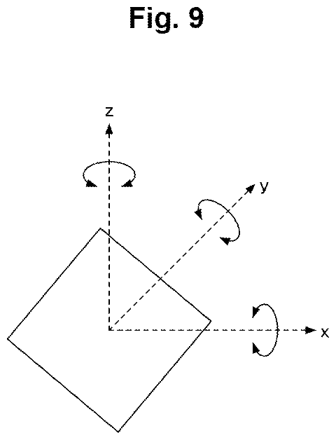

FIG. 9 illustrates an example of one antenna element disposed on a spherical surface. As illustrated in FIG. 9, since the antenna element can rotate on each of an x axis, a y axis, and a z axis, the antenna element can be directed in any direction.

### (Configuration Example of Transmission Device (Transmission Apparatus))

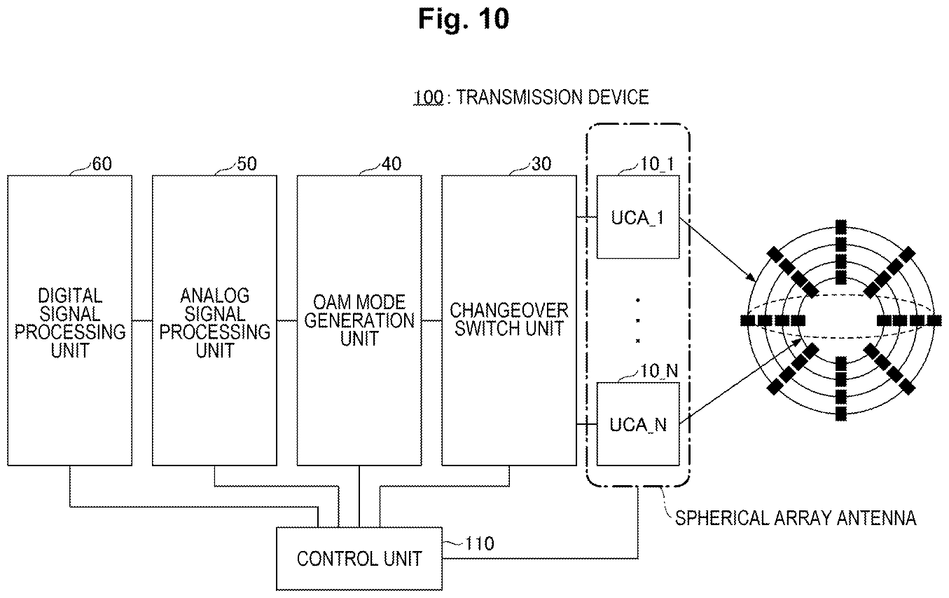

FIG. 10 illustrates a configuration example of the transmission device 100 (transmission apparatus) including the above-described spherical array antenna. As illustrated in FIG. 10, the transmission device 100 includes the spherical array antenna, a changeover switch unit 30, an OAM mode generation unit 40, an analog signal processing unit 50, a digital signal processing unit 60, and a control unit 110.

In the example in FIG. 10, it is assumed that there are N selectable UCAs in the spherical array antenna, and these UCAs are illustrated as UCAs 10_1 to 10_N. FIG. 10 illustrates that each of the UCAs 10_1 to 10_N is one UCA selected in the spherical array antenna. A functional outline of each unit is as follows.

The digital signal processing unit 60 generates a digital signal to be transmitted on a carrier wave from input data, and outputs the generated digital signal to the analog signal processing unit 50. The analog signal processing unit 50 converts the digital signal into an analog signal.

The OAM mode generation unit 40 generates one or a plurality of OAM mode signals from the input analog signal, and outputs the generated signal to the changeover switch unit 30.

The changeover switch unit 30 transmits the signal generated by the OAM mode generation unit 40 to the selected one or more UCAs on the basis of an instruction from the control unit 110. As a result, OAM multiplex transmission in one direction, OAM multiplex transmission in a plurality of directions, OAM-MIMO multiplex transmission in one direction, OAM-MIMO multiplex transmission in a plurality of directions, simultaneous transmission of OAM multiplex transmission in one direction and OAM-MIMO multiplex transmission in another direction, and the like can be performed from the spherical array antenna.

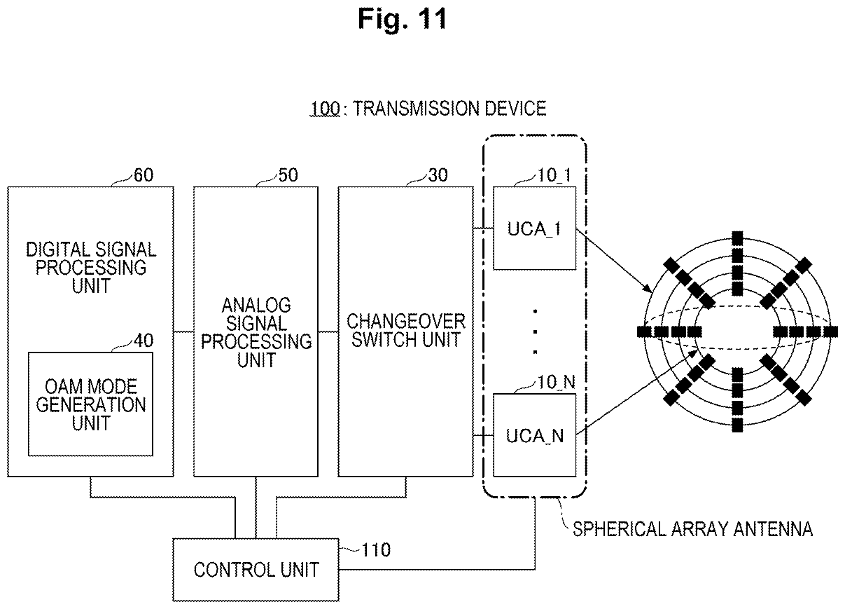

In the configuration example in FIG. 10, it is assumed that a Butler circuit or the like that generates an OAM mode signal from an analog signal is used as the OAM mode generation unit 40, but this is an example. For example, an OAM mode signal may be generated through digital signal processing, the digital OAM mode signal may be converted into an analog signal, and the analog signal may be supplied to a UCA. In this case, as illustrated in FIG. 11, the OAM mode generation unit 40 is a part of the digital signal processing unit 60 and outputs the analog signal converted by the analog signal processing unit 50 to the changeover switch unit 30.

Note that connection using the changeover switch unit 30 may be a physical (mechanical) connection, or may be a method of selecting a specific frequency corresponding to the selected UCA, or the like.

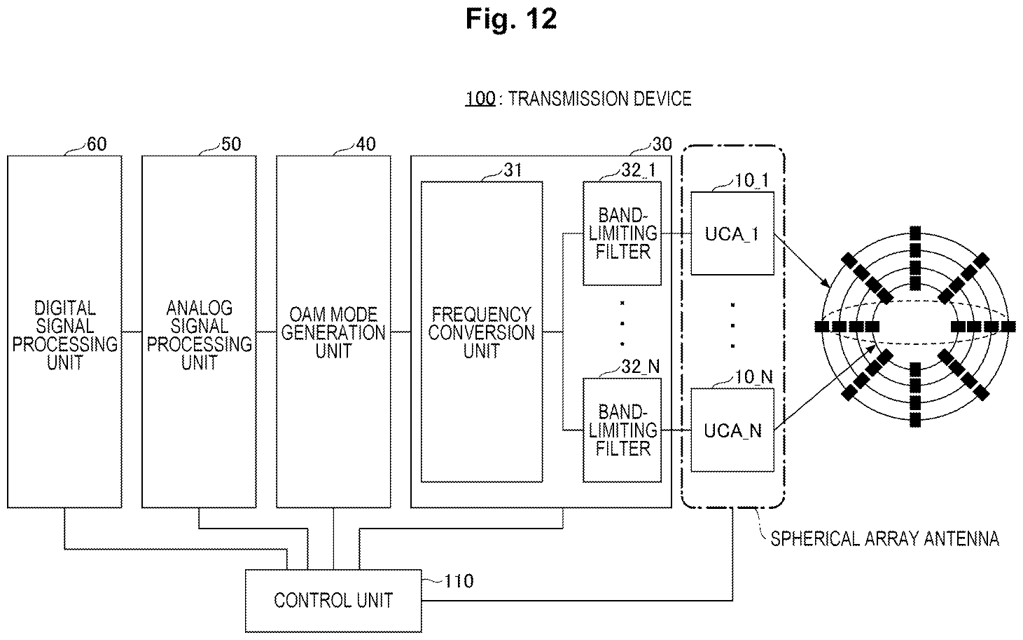

In the case of the method of selecting a frequency, for example, as illustrated in FIG. 12, the changeover switch unit 30 includes a frequency conversion unit 31 and a plurality of band-limiting filters 32 through which only frequencies corresponding to the UCAs are allowed to pass, and the band-limiting filters 32 are respectively connected to the corresponding UCAs. The control unit 110 instructs the frequency conversion unit 31 to set an OAM mode signal input to the changeover switch unit 30 to a frequency that matches a corresponding UCA. Alternatively, the control unit 110 designates a frequency of a carrier wave for the analog signal processing unit 50 according to the frequency corresponding to the UCA instead of the processing of the frequency conversion unit 31.

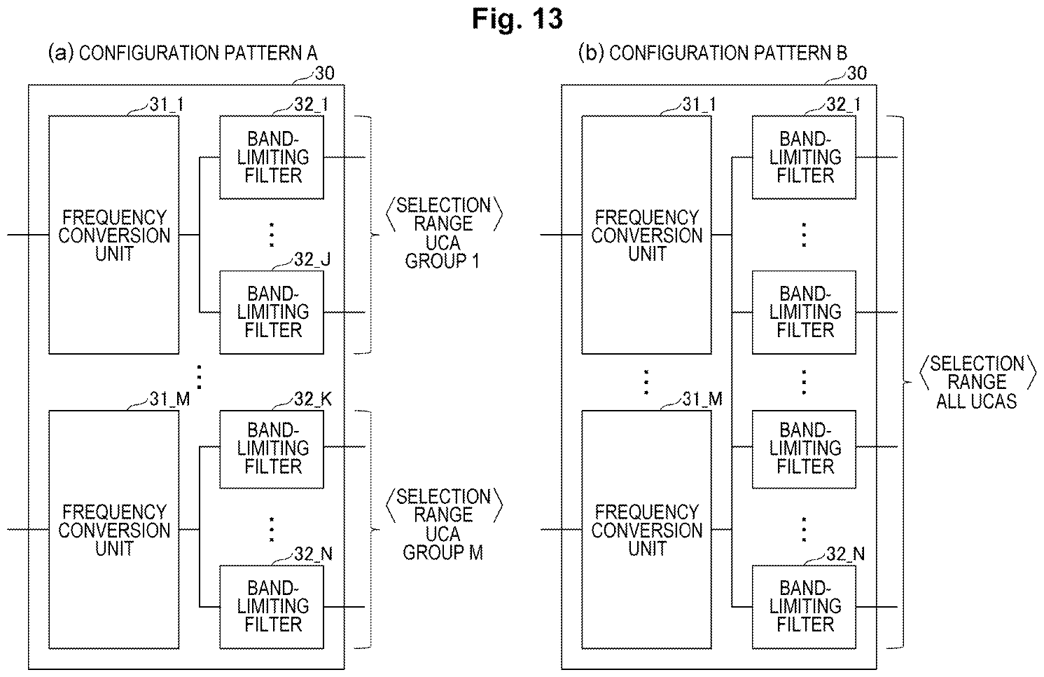

Further, for example, as in a case where the OAM signal in the OAM mode 1 is transmitted in the UCA_1 and the OAM signal in the OAM mode 2 is transmitted in the UCA_2, a configuration example of the changeover switch unit 30 in a case where a plurality of OAM signals are transmitted in different UCAs is illustrated in FIG. 13. The changeover switch unit 30 illustrated in FIG. 12 is replaced with the changeover switch unit 30 in a configuration pattern A in FIG. 13(a) or the changeover switch unit 30 in a configuration pattern B in FIG. 13(b).

In the configuration pattern A in FIG. 13(a), M frequency conversion units 31_1 to 31_M corresponding to UCA groups 1 to M are provided. Each UCA group includes one or more UCAs. One or more band-limiting filters 32 connected to UCAs of a corresponding UCA group are connected to each of the frequency conversion units 31 via a branch.

A signal output from each frequency conversion unit 31 is demultiplexed at a branch and is supplied to each band-limiting filter 32 to be connected, and a signal is output from the band-limiting filter 32 through which the signal is allowed to pass. In the configuration pattern A in FIG. 13(a), multiplexing is not performed between the different frequency conversion units 31.

In the configuration pattern A in FIG. 13(a), as an example, in a case where an OAM signal is transmitted by using two UCAs, for example, one UCA is selected from the UCA group 1, and one UCA is selected from the UCA group M.

In the configuration pattern B in FIG. 13(b), M frequency conversion units 31_1 to 31_M are provided, and all the UCAs are included in a selection range for each frequency conversion unit 31. Each frequency conversion unit 31 is connected to the band-limiting filters 32_1 to 32_N via a branch. A signal output from each frequency conversion unit 31 is demultiplexed at a branch and is supplied to each band-limiting filter 32, and a signal is output from the band-limiting filter 32 through which the signal is allowed to pass.

In the configuration pattern B in FIG. 13(b), multiplexing is performed between the different frequency conversion units 31, but even if the multiplexing is performed, signals are not mixed if frequency bands are different.

In the configuration pattern B in FIG. 13(b), as an example, in a case where an OAM signal is transmitted by using two UCAs, for example, the UCA_1 and the UCA_N are selected. In this case, a certain frequency conversion unit 31 outputs a signal to pass through the band-limiting filter 32_1 connected to the UCA_1, and another frequency conversion unit 31 outputs a signal to pass through the band-limiting filter 32_N connected to the UCA_N.

A hybrid configuration having both of the configuration of the configuration pattern A (configuration of performing only demultiplexing) and the configuration of the configuration pattern B (configuration of performing demultiplexing and multiplexing) may be used.

Although the configurations in FIGS. 12 and 13 correspond to the configuration in FIG. 10, a configuration of the changeover switch unit 30 in the case of employing the method of selecting a frequency is similar to the configuration of the changeover switch unit 30 illustrated in FIGS. 12 and 13 even in the case of the configuration in FIG. 11.

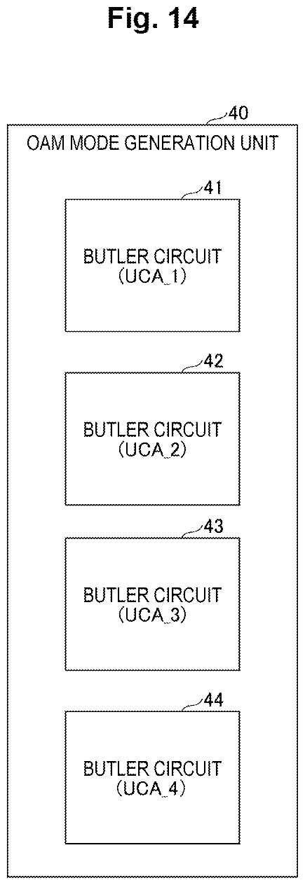

FIG. 14 illustrates a configuration example of the OAM mode generation unit 40 in a case where the Butler circuit is used. In the example illustrated in FIG. 14, there are four Butler circuits 41 to 44. The number of Butler circuits included in the OAM mode generation unit 40 corresponds to the number of UCAs simultaneously selected from the spherical array antenna. FIG. 14 includes four Butler circuits 41 to 44, but the four Butler circuits are an example.

For example, in a case where the UCA_1, the UCA_2, the UCA_3, and the UCA_4 are selected from the spherical array antenna and OAM multiplex transmission is simultaneously performed in four directions, the Butler circuits 41 to 44 each transmit one or a plurality of OAM mode signals to a corresponding UCA (a UCA connected via the changeover switch unit 30). For example, in a case where each UCA multiplexes the OAM mode 1 and the OAM mode 2, signals in the OAM mode 1 and the signal of the OAM mode 2 are supplied to each UCA.

For example, in a case where four UCAs having different concentric diameters such as the UCA_1, the UCA_2, the UCA_3, and the UCA_4 are selected from the spherical array antenna and OAM-MIMO multiplex transmission is performed, signals in one or a plurality of OAM modes are supplied from each Butler circuit to the corresponding UCA in the same manner as described above.

As an example, assuming that a UCA connected to one Butler circuit includes eight antenna elements, in a case where the OAM mode 1 and the OAM mode −1 are multiplexed, the Butler circuit includes eight output ports, and a signal obtained by multiplexing a signal having a phase difference of 45° (360°/8) counterclockwise and a signal having a phase difference of −45° counterclockwise is output from each output port. The signal from each output port is provided to a corresponding antenna element.

A signal obtained by multiplexing two signals having the following phases is output from each antenna element of the UCA.

The antenna element #1=(0°, 0°), the antenna element #2=(45°, −45°), the antenna element #3=(900, −90°), the antenna element #4=(135°, −135°), the antenna element #5=(180°, −180°), the antenna element #6=(225°, −225°), the antenna element #7=(270°, −270°), and the antenna element #8=(315, −315°).

### Operation Example

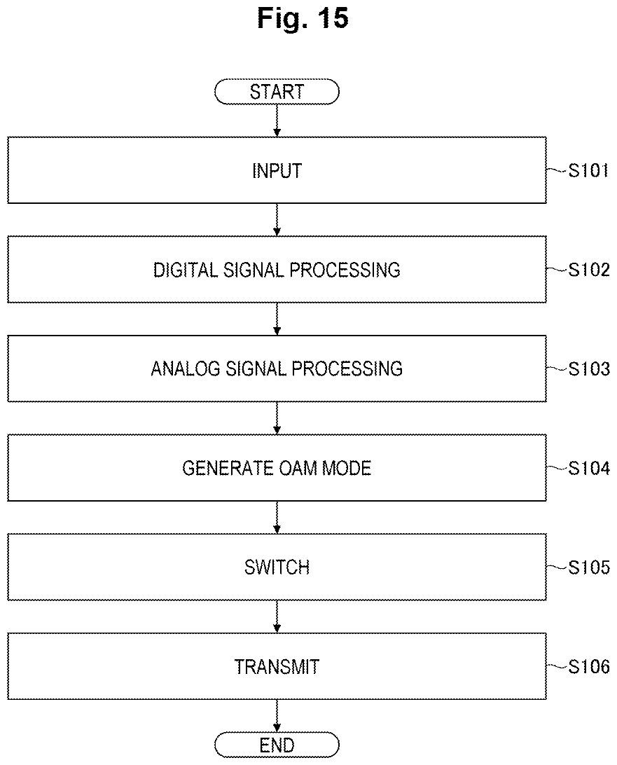

An operation example of the transmission device 100 in the present embodiment will be described with reference to a flowchart of FIG. 15.

In S101, data is input to the digital signal processing unit 60. In S102, the digital signal processing unit 60 generates a digital signal to be transmitted on a carrier wave from the input data, and outputs the generated digital signal to the analog signal processing unit 50.

In S103, the analog signal processing unit 50 converts the digital signal into an analog signal (digital-analog conversion), and converts a frequency of the output signal into a frequency band (for example, 28 GHz band) of the carrier wave. The analog signal processing unit 50 inputs the generated analog signal to the OAM mode generation unit 40.

Here, assuming that the QAM mode generation unit 40 has a configuration using the Butler circuits illustrated in FIG. 14 and performs simultaneous OAM multiplex transmission in the OAM modes 1 and −1 with the four UCAs, a signal transmitted in the OAM mode 1 and a signal transmitted in the OAM mode −1 are input from the analog signal processing unit 50 to each Butler circuit of the OAM mode generation unit 40.

In S104, each Butler circuit in the OAM mode generation unit 40 generates a signal in the OAM mode, and outputs the generated signal from each output port. In S105, a signal is supplied to each antenna element of each UCA used for transmission by the changeover switch unit 30, and is transmitted in S106.

### (Control)

As described above, the transmission device 100 can select a UCA having a transmission axis in any direction from the spherical array antenna and perform OAM multiplex transmission in the direction. Control for this purpose is executed by the control unit 110. Hereinafter, an example of control performed by the control unit 110 will be described.

It is assumed that the control unit 110 of the transmission device 100 ascertains a position of each reception device (a direction in which the reception device is located with respect to the transmission device 100 may be used). The control unit 110 of the transmission device 100 may use any method as a method of ascertaining a state on the reception side (the position of the reception device or the like). For example, the control unit 110 may ascertain the position of the reception device by receiving a reference signal transmitted from the reception device, or may ascertain the position of the reception device by receiving position information transmitted from the reception device. The position (a fixed position, a planned movement position at each time, or the like) of the reception device may be set in the control unit 110 in advance.

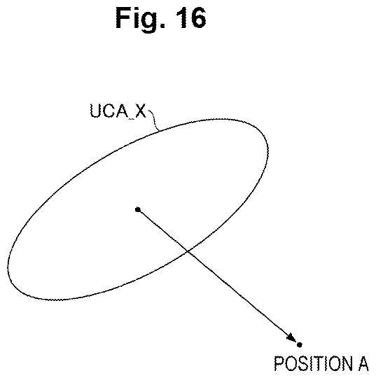

For example, when the control unit 110 determines that the reception device that is a signal transmission target is at a position A illustrated in FIG. 16, the control unit 110 selects the UCA_X including a plurality of antenna elements on a plane perpendicular to the direction (transmission axis) from the transmission device 100 (spherical array antenna) to the position A, and instructs the changeover switch unit 30 to connect the selected the UCA_X to the OAM mode generation unit 40, and the changeover switch unit 30 connects the selected the UCA_X to the OAM mode generation unit 40 in response to the instruction.

The control unit 110 instructs the spherical array antenna to direct a direction of each antenna element in the selected UCA_X to the transmission direction (transmission axis direction), and the spherical array antenna is directed to the direction of each antenna element in the UCA_X to the transmission direction.

Note that, in a case where a plurality of UCAs including a plurality of antenna elements on a plane perpendicular to the transmission axis can be selected, any one of a plurality of UCAs or a plurality of or all of UCAs may be selected to perform OAM-MIMO multiplex transmission.

In a case where a plurality of UCAs including a plurality of antenna elements on a plane perpendicular to the transmission axis can be selected, a signal may be transmitted by each UCA, and one UCA having the best reception quality may be selected and used on the basis of feedback from the reception device.

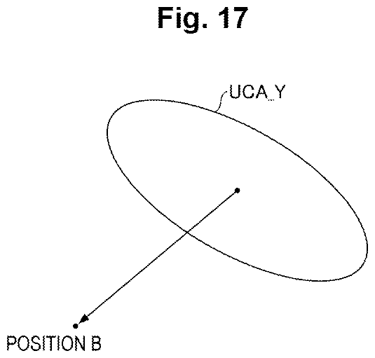

As illustrated in FIG. 17, also in a case where the reception device is present at a position B different from the position A, similarly to the case in FIG. 16, the UCA_Y suitable for the position B is selected and a signal is transmitted. the UCA_X and the UCA_Y may be simultaneously used to perform transmission.

In a case where the reception device at position A illustrated in FIG. 16 moves, the control unit 110 tracks the movement of the reception device. That is, as described above, it is assumed that the control unit 110 constantly ascertains a position of the reception device.

For example, in a case where an angle between the transmission axis of the UCA_X selected before the movement and the transmission axis after the movement is equal to or more than a certain threshold value, the control unit 110 switches the UCA for communication with the reception device from the UCA_X to another UCA. That is, when the position of the reception device after the movement is a position A′, the control unit 110 selects a UCA_X′ including a plurality of antenna elements on a plane perpendicular to the direction (transmission axis) from the transmission device 100 (spherical array antenna) to the position A′, and switches the UCA for communication with the reception device from the UCA_X to the UCA_X′.

### Effects of Embodiment

The technology according to the present embodiment described above enables multidirectional support and movement following in a transmission device using a UCA. OAM or OAM-MIMO multiplex transmission can be performed with axes aligned in a plurality of any directions. Further, it is possible to change the transmission axis by switching UCAs and follow the movement.

### Summary of Embodiment

In the present specification, at least the transmission device and the transmission method described in the following clauses are described.

### (Clause 1)

A transmission device including:
a spherical array antenna including a plurality of antenna elements on a spherical surface; and
a control unit that selects a plurality of antenna elements present on any circle from among the plurality of antenna elements of the spherical array antenna as a UCA and causes the selected UCA to perform OAM transmission.

### (Clause 2)

The transmission device according to clause 1, in which
the control unit selects a plurality of UCAs from among the plurality of antenna elements of the spherical array antenna, and causes the selected plurality of UCAs to perform OAM transmission in a plurality of directions.

### (Clause 3)

The transmission device according to clause 1 or 2, in which
the control unit selects a plurality of UCAs having different concentric diameters from among the plurality of antenna elements of the spherical array antenna, and causes the selected plurality of UCAs to perform OAM-MIMO transmission.

### (Clause 4)

The transmission device according to any one of clauses 1 to 3, in which
the control unit switches UCAs according to movement of a reception device.

### (Clause 5)

The transmission device according to any one of clauses 1 to 4, in which
the control unit directs a direction of each antenna element configuring the selected UCA to a transmission direction.

### (Clause 6)

A transmission method executed by a transmission device having a spherical array antenna including a plurality of antenna elements on a spherical surface, the transmission method including:
selecting a plurality of antenna elements present on any circle as a UCA from among the plurality of antenna elements of the spherical array antenna, and performing OAM transmission by the selected UCA.

Although the present embodiment has been described above, the present invention is not limited to such a specific embodiment, and various modifications and changes can be made within the scope of the concept of the present invention disclosed in the claims.

### REFERENCE SIGNS LIST

10 UCA
30 Changeover switch unit
31 Frequency conversion unit
32 Band-limiting filter
40 OAM mode generation unit
50 Analog signal processing unit
60 Digital signal processing unit
100 Transmission device
110 Control unit

1. A transmission apparatus comprising:
a spherical array antenna including a plurality of antenna elements on a spherical surface;
a processor; and
a memory that includes instructions, which when executed, cause the processor to execute a method, said method including:
selecting a plurality of antenna elements present on any circle from among the plurality of antenna elements of the spherical array antenna as a uniform circular array (UCA) and causing the selected UCA to perform orbital angular momentum (OAM) transmission.

2. The transmission apparatus according to claim 1, wherein
the selecting includes selecting a plurality of UCAs from among the plurality of antenna elements of the spherical array antenna, and the causing includes causing the selected plurality of UCAs to perform OAM transmission in a plurality of directions.

3. The transmission apparatus according to claim 1, wherein
the selecting includes selecting a plurality of UCAs having different concentric diameters from among the plurality of antenna elements of the spherical array antenna, and the causing includes causing the selected plurality of UCAs to perform OAM-MIMO transmission.

4. The transmission apparatus according to claim 1, wherein
said method further includes switching UCAs according to movement of a reception device.

5. The transmission apparatus according to claim 1, wherein
said method further includes directing a direction of each antenna element configuring the selected UCA to a transmission direction.

6. A transmission method executed by a transmission apparatus having a spherical array antenna including a plurality of antenna elements on a spherical surface, the transmission method comprising:
selecting a plurality of antenna elements present on any circle as a UCA from among the plurality of antenna elements of the spherical array antenna, and performing OAM transmission by the selected UCA.
